(19) United States
(12) Patent Application Publication
(10) Pub. No.: US 2012/0236678 A1
(43) Pub. Date: Sep. 20, 2012

(54) COMPACT FLOW-THROUGH NANOCAVITATION MIXER APPARATUS WITH CHAMBER-IN-CHAMBER DESIGN FOR ADVANCED HEAT EXCHANGE

(75) Inventors: Roman Gordon, Studio City, CA (US); Igor Gorodnitsky, Marina del Rey, CA (US); Viktor Grichko, San Marcos, CA (US); Maxim Promtov, Tambov (RU)

(73) Assignee: CAVITATION TECHNOLOGIES, INC., Chatsworth, CA (US)

(21) Appl. No.: 13/050,878

(22) Filed: Mar. 17, 2011

(51) Int. Cl. B01F 5/06; B01F 11/02; B01F 15/06

(52) U.S. Cl. 366/108; 366/144

(57) ABSTRACT

A flow-through, chamber-in-chamber, nanocavitation apparatus having an elongated housing with an inlet and an outlet. A working chamber disposed between the inlet and the outlet includes alternating radial and central flow guides disposed concentrically in the working chamber about a central axis. A first radial flow guide is disposed proximate to the inlet and all radial flow guides have a radial opening adjacent to an inner wall of the housing. A first central flow guide is disposed proximate to the outlet and has a central opening about the central axis. The alternating concentric nature of the flow guides promotes alternating generation and collapse of cavitational features, all while promoting the efficient exchange of heat between hot zones and cooler regions of adjacent flow guides.

### BACKGROUND OF THE INVENTION

The invention generally relates to the flow-through, high-shear mixers and cavitation apparati that are utilized for processing heterogeneous and homogeneous fluidic mixtures through the controlled formation of cavitation bubbles and uses the energy released upon the implosion of these bubbles to alter said fluids. The device is meant for preparing mixtures, solutions, emulsions and dispersions with the particle sizes that can be smaller than one micron, particle and nanoparticle synthesis, carrying out reactions and processes and improving composition, mass and heat transfer and is expected to find applications in food, pharmaceutical, chemical, oil, fuel and other industries.

More particularly, the apparatus relates to the modification of fluids composed of different compounds by using the implosion energy of cavitation bubbles to improve the homogeny, viscosity, and/or other physical characteristics of the fluids, as well as, alter their chemical composition, and obtain upgraded or altered products of higher value.

Cavitation can be of different origins, for instance, acoustic, hydrodynamic or generated with laser light, an electrical discharge or steam injection (Gogate, 2008; Mahulkar et al., 2008). Hydrodynamic cavitation comprises the vaporization, generation, growth, pulsation and collapse of bubbles which occur in a flowing liquid as a result of a decrease and subsequent increase in the hydrostatic pressure and can be achieved by passing the liquid through a constricted zone at sufficient velocity. Cavitation onsets after the hydrostatic pressure of the liquid has decreased to the saturated vapor pressure of the liquid or its components and is categorized by a cavitation number Cᵥ. Cavitation ideally begins at Cᵥ equals 1, where a Cᵥ less than 1 indicates a high degree of cavitation. Other important considerations are the number of cavitation events in a flow unit, the surface tension, and the size of bubbles, which range from ten nanometers to a few microns or even larger in diameter (Gogate, 2008; Passandideh-Fard and Roohi, 2008).

The eventual collapse of the bubbles results in a localized increase in pressure and temperature. The combination of elevated pressure and temperature along with vigorous mixing supplied by the hydrodynamic cavitation triggers and accelerates numerous reactions and processes. These actions enhance the reaction yield and process efficiency by means of the energy released upon the collapse of the cavitation bubbles. Such enhanced reaction yield and process efficiency has found application in mixing, emulsification and the expedition of chemical reactions. While extreme pressure or heat can be unfavorable, the outcome of controlled cavitation-assisted processing has been shown to be beneficial.

When fluid is processed in a flow-through cavitation mixing device at a suitable velocity, the decrease in hydrostatic pressure results in the formation of cavitation bubbles. Small particles and impurities in the liquid serve as nuclei for these bubbles. When the cavitation bubbles relocate to a high-pressure zone they will implode within a short time. The collapse of bubbles is asymmetrical because the surrounding liquid rushes in to fill the void forming a micro jet that subsequently ruptures the bubble with tremendous force. The implosion is accompanied by a significant jump in both the local pressure and temperature up to 1,000 atm and 5,000° C., respectively, and the formation of shock waves (Suslick, 1989; Didenko et al., 1999; Suslick et al., 1999). The released energy activates atoms, molecules, ions or radicals located in the bubbles and surrounding fluid, initiates reactions and processes and dissipates into the surrounding fluid. The implosion may be accompanied by the emission of UV and/or visible light, which promotes photochemical reactions and generates radicals (Sharma et al., 2008; Kalva et al., 2009).

Numerous flow-through hydrodynamic cavitation devices are known. See, for example, U.S. Pat. No. 6,705,396 to Ivannikov et al., U.S. Pat. Nos. 7,207,712, 6502,979, 5,969,207 and 5,971,601 to Kozyuk, and U.S. Pat. No. 7,762,715 to Gordon et al.

U.S. Pat. No. 7,338,551 to Kozyuk discloses a method and device for generating bubbles in liquid that passes through a first local constriction of the device at a velocity of at least 12 m/s and then is mixed with gas to affect implosion within the second cavitation field. Since this device provides two cavitation zones the treatment outcome may be unsatisfactory when more consecutive cavitations are desired. It should be noted that the device is not designed for an advanced heat exchange between the low-pressure and high-pressure compartments, which can lead to overheating and loss in efficiency.

In contrast to sonic or ultrasonic cavitation devices, the flow-through hydrodynamic apparatuses do not require using a vessel. The efficiency of sonic or ultrasonic processing performed in a static vessel is insufficient because the effect diminishes with an increase in distance from the radiation source. The achieved fluid alterations are not uniform and occur at specific locations in the vessel, depending on the frequency and interference patterns. Thus, processing fluids via sonic or ultrasonic cavitation does not offer an optimized method.

At the present time, with energy costs rapidly rising, it is highly desirable to reduce both treatment time and energy consumption to secure a profit margin as large as possible. However, the prior art techniques do not offer the most efficient and safest methods of blending, emulsifying, altering or upgrading fluids in the shortest time possible. Thus, there exists a need for an advanced flow-through cavitation device for processing thermal sensitive liquids within a minimal time at a low cost that would result in the products with improved characteristics. An advanced, compact, and highly efficient apparatus is particularly needed at pharmaceutical plants and feedstock processing locations and refineries, where throughput is a key factor. The present invention provides such a device while upgrading products expeditiously.

### SUMMARY OF THE INVENTION

The present invention provides a unique method for manipulating fluids. This goal is achieved via the chamber-in-chamber design of a multi-stage flow-through cavitation mixing device aimed at the expeditious modification of thermo-sensitive or flammable liquids, solutions and compounds. In accordance with the present invention, the method comprises feeding fluidic flow with a discharge pump and/or a downstream suction pump set at proper pressure in an array of low-pressure and high-pressure chambers separated with vortex turbulizers to afford the chamber-in-chamber compact design, advanced heat exchange, rapid mass transfer, high treatment efficiency and superior capacity, and supplying other conditions of choice.

In addition to the objects and advantages of the fluids' manipulation described in this patent application, several objects and advantages of the present invention are:
(1) to provide a compact flow-through nanocavitation device for processing fluids in an expedited manner with optimized energy and maintenance costs;
(2) to reduce space taken up by the processing equipment;
(3) to provide conditions for blending, emulsification, altering and upgrading thermo-sensitive fluids and flammable compounds by passing them through the bubble-generating chamber that houses a high-pressure chamber wherein the cavitation bubbles' implosion occurs to provide the advanced conditions for rapid heat exchange;
(4) to provide conditions for gradual, multi-step alteration of fluids by subjecting them to the first cavitation event followed by subjecting the residual original compounds and products of the reactions to the second cavitation event, etc.
(5) to provide a compact, flow-through apparatus for manipulating fluids at the site of production;
(6) to generate a uniform cavitation field throughout the reaction chamber for a time period allowing the desired changes to take place.

The present invention is directed to a compact, flow-through nanocavitation mixer apparatus with a chamber-in-chamber design for advanced heat exchange. The mixer apparatus comprises an elongated housing having an inlet and an outlet, defining a working chamber between the inlet and the outlet, and having a central axis passing longitudinally through the center of the housing. Within the working chamber a first radial flow guide and a first central flow guide are concentrically disposed about the central axis. The first radial flow guide is proximate or adjacent to the inlet and the first central flow guide is disposed proximate or adjacent to the outlet. The first radial flow guide has a radial opening adjacent to an inner wall of the housing. The first central flow guide has a central opening about the central axis. The first radial flow guide and the first central flow guide are generally conical in shape and nested one within the other.

Each of the first radial flow guide and the first central flow guide have interior and exterior tapered conical surfaces configured such that an exterior angle α between the exterior tapered conical surface and the central axis is between zero degrees and one hundred eighty degrees. Preferably, the angle α is an obtuse angle between 90° and 180°. In a particularly preferred embodiment, the exterior angle α is between 115° and 150°.

The mixer apparatus may also comprise a hollow cylinder having a downstream first end disposed in a sealed manner in the central opening of the first central flow guide and an upstream second end abutting in a sealed manner against the peak of the first radial flow guide. The hollow cylinder has a plurality of side wall openings disposed around the hollow cylinder and passing through the side wall of the hollow cylinder. The side wall openings of the hollow cylinder may be arranged in rows or columns around the hollow cylinder axis and may be canted relative to the central axis. Each of the plurality of side wall openings are canted at the same angle or at different angles.

A coaxial disc is disposed in a sealed manner in the central opening of the first central flow guide, abutting against the downstream first end of the hollow cylinder. The coaxial disc has a channel passing therethrough. Preferably, the coaxial disc has a plurality of channels passing therethrough, wherein said channels cross within the coaxial disc or along extended axes of the channels outside the coaxial disc.

The mixer apparatus preferably comprises a plurality of alternating radial and central flow guides. A particular central flow guide is spaced from a preceding radial flow guide by a hollow cylinder affixed in the central opening and abutting against said preceding radial flow guide. A particular radial flow guide is spaced from a preceding central flow guide by a spacer ring abutting against both flow guides. In this configuration, the mixer apparatus has the first radial flow guide disposed proximate or adjacent to the inlet and the first central flow guide disposed proximate or adjacent to the outlet.

The outlet of the mixer apparatus may also comprise a diffuser, wherein the diffuser is configured as a cone with a gradually expanding cross-sectional area. The diffuser is connected to a hollow cylinder, the hollow cylinder being disposed in the central opening of the first central flow guide and in an abutting relationship to a second radial flow guide proximate to the outlet.

The mixer apparatus may also comprise an end cap in the outlet. The end cap has a generally elongated, cylindrical opening, an end disc disposed in the end cap and a baffle body mounted on the end disc oriented toward a second radial flow guide proximate to the outlet. The end disc has outlet channels disposed around the perimeter of the baffle body. Vibration strips are mounted in the end cap such that a free end of each of the vibration strips is disposed adjacent to one of said outlet channels.

The first radial flow guide and the first central flow guide may be generally planar in shape such that a right angle exists between a facing surface of the flow guides and the central axis. A second radial flow guide may be disposed proximate to the outlet, between the outlet and the first central flow guide. The inlet may comprise an inlet flange and the outlet may comprise an outlet flange. A first spacer ring may be disposed between the first radial flow guide and the inlet flange and a second spacer ring may be disposed between the second radial flow guide and the outlet flange. The mixer apparatus preferably comprises a plurality of alternating radial and central flow guides, wherein a particular radial flow guide is spaced from an adjacent central flow guide or an inlet or outlet flange by a spacer ring abutting against both.

The first radial flow guide and the first central flow guide may be made from materials selected from the group consisting of a STELLITE® alloy, steel, stainless steel, aluminum, copper, brass, silver, zinc, nickel, PTFE, FEP or other fluoropolymers, poly (methyl methacrylate), PEEK, PBAT, PETG, PVC, polycarbonates, acrylic materials, and polycrystalline diamond. Preferably, all parts of the compact, flow-through nanocavitation mixer apparatus are made from materials selected from the group consisting of a STELLITE® alloy, steel, stainless steel, aluminum, copper, brass, silver, zinc, nickel, PTFE, FEP or other fluoropolymers, poly (methyl methacrylate), PEEK, PBAT, PETG, PVC, polycarbonates, acrylic materials, and polycrystalline diamond.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a cross-sectional view of a first preferred embodiment of the compact, flow-through, chamber-in-chamber nanocavitation mixer apparatus of the present invention;

FIG. 2 is a close-up view of the cavitation apparatus indicated by line 2-2 of FIG. 1;

FIG. 3 is a close-up view of the outlet pipe of the cavitation apparatus illustrating an alternate construction;

FIG. 4 is a cross-sectional view of a second preferred embodiment of the compact, flow-through, chamber-in-chamber nanocavitation mixer apparatus of the present invention;

FIG. 5 illustrates a front view of the flow plate of the second preferred embodiment;

FIG. 6 is a cross-sectional view taken along line 6-6 of FIG. 5.

### DETAILED DESCRIPTION OF THE PREFERRED EMBODIMENTS

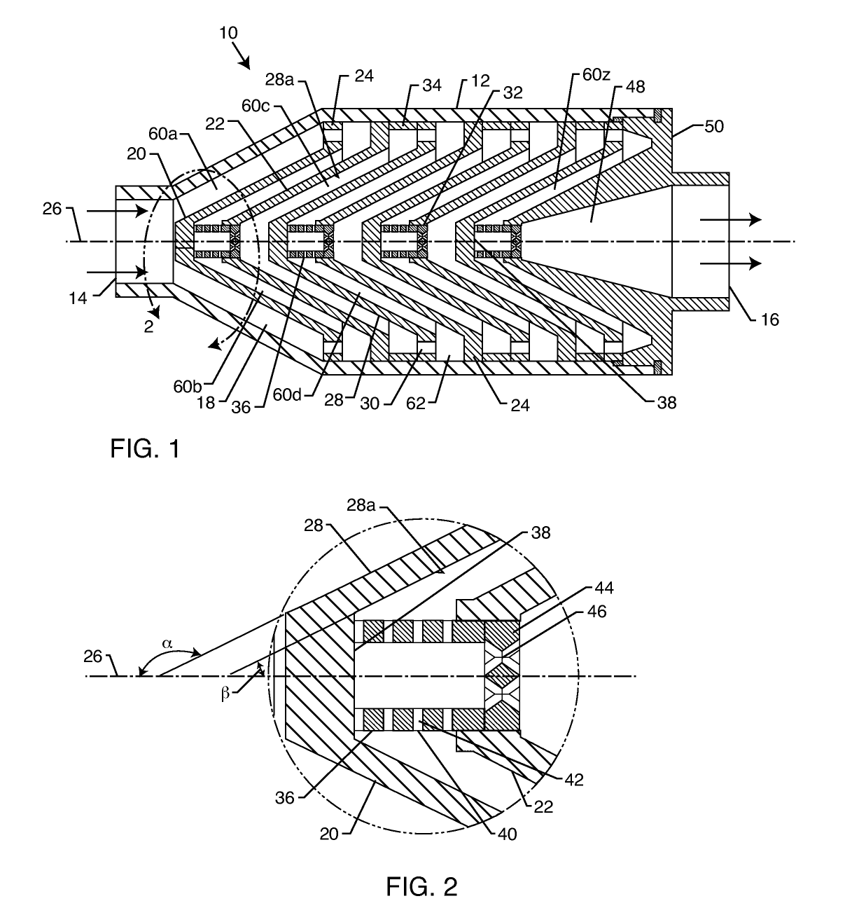

With reference now to FIGS. 1-6, the flow-through, multi-stage, chamber-in-chamber nanocavitation mixer apparatus of the present invention, is generally referred to by reference numerals 10 and 70, representing alternate embodiments. The apparatus 10, 70 is especially suitable for processing viscous and thermo-sensitive fluids, such as organic solvents, crude oil, cell extracts, biological fluids, pharmaceutical emulsions and solutions, etc.

The term “fluid” includes but is not limited to a pure liquid comprised of identical molecules, a homogeneous or heterogeneous fluidic mixture, media liquefied prior to cavitation treatment, two- or multi-phase systems including crude oil, water/oil and/or other emulsions and dispersions, salt solutions, gases and/or other matter dissolved in suitable solvent(s), melted matter, dispersions, suspensions, slurries, liquefied gases, cell culture or broth, biological fluids, tissues, and the mixtures thereof.

The objects of the present invention are achieved by forcing fluids in the flow-through cavitation apparatus 10, 70 to induce reactions and/or processes and/or change the properties of these fluids. The hydrodynamic nanocavitation process assumes the formation of vapor-filled bubbles ranging in diameter from nanometers to microns or larger within the fluid when accelerated to a proper velocity. The phenomenon is called cavitation, because cavities form when the liquid pressure has been reduced to its vapor pressure. The bubbles expand and suddenly collapse upon reaching a high-pressure zone. The violent implosion causes a spike in pressure and temperature and intense shearing forces, resulting in reactions, mixing, emulsion formation and other effects.

Usually, when a multi-component fluidic mixture moves through a multi-stage cavitation apparatus the most volatile components will form vapor bubbles first and the other components will follow in the order of increasing boiling points. With the proposed chamber-in-chamber device 10, 70 the components will form vapor bubbles leading to different reactions in different chambers and exhibit the different behavior, depending on the value of angles α and β, the size and direction of openings, the properties of material from which the device 10, 70 is made, the rate of heat exchange and other characteristics.

A first preferred embodiment of the flow-through, multi-stage, chamber-in-chamber nanocavitation mixer apparatus 10 is depicted in FIGS. 1-3. The various parts of the apparatus 10 can be fabricated from a STELLITE® alloy, steel, stainless steel, aluminum, copper, brass, silver, zinc, nickel, PTFE, FEP or other fluoropolymers, poly (methyl methacrylate), PEEK, PBAT, PETG, PVC, polycarbonates, acrylic materials, polycrystalline diamond or other finished or unfinished metals and material(s) with the required thermal conductivity an/or optical transparency. The apparatus 10 comprises a housing 12 having an inlet pipe 14 and an outlet pipe 16 for connecting in-line with an industrial pipeline (not shown). Housing 12 can have a circular, elliptical or polygonal cross-section and may be provided with gas/liquid inlet port(s) (not shown).

The housing 12 encloses a working chamber 18 that contains alternating radial flow guide 20 and central flow guide 22. The flow guides 20 and 22 are shaped as truncated circular, elliptical or polygonal cones depending upon the desired cross-sectional shape. Every flow guide 20, 22 comprises beaded flanges 24 for aligning the guides 20, 22 within the housing 12. The flow guides 20, 22 are disposed within the working chamber 18 in a fully or partially nested, concentric configuration about a central axis 26 of the device 10. The exterior angle α between the central axis 26 and the exterior tapered conical surfaces 28 of the flow guides 20, 22 may comprise any angle between 0 and 180 degrees (0°<α<180°). The interior angle β between the central axis 26 and the interior tapered conical surface 28a of the flow guides 20, 22 may also comprise any angle between 0 and 180 degrees (0°<β<180°). In a preferred embodiment, such exterior angle α is preferably an obtuse angle) (90°<α<180°) and such interior angle β is preferably an acute angle (0°<β<90°). In a particularly preferred embodiment, the exterior angle α is between 115 and 150 degrees (115°<α<150°) and the interior angle β is between 25 and 60 degrees (25°<β<60°). The angles α and β and not required to be supplementary angles, meaning that the sum of angles α and β can differ from 180° if the thickness of flow guides 20,22 varies along the tapered conical surfaces, i.e., the interior and exterior tapered conical surfaces are not parallel. The flow guides 20, 22 are preferably manufactured from materials with a relatively high thermal conductivity. If cavitation is expected to be accompanied by the emission of light, the flow guides are preferably manufactured from materials transparent to UV and/or visible light. The tapered conical surfaces 28 of the flow guides 20, 22 may be provided with grooves and/or protrusions to increase the effect on fluid pressure as described below. These grooves and/or protrusions may comprise concentric terrace folds or radial linear, wavy or spiral ribs.

As mentioned above, the flow guides 20, 22 are disposed in an alternating pattern. The first upstream flow guide 20, referred to as a radial flow guide, includes radial openings 30 disposed on the beaded flanges 24. The radial openings 30 may be circular, rectangular, trapezoidal, slotted and/or any different shape in the beaded flange 24. The second downstream flow guide 22, referred to as a central flow guide, includes a central opening 32 disposed at the peak of the cone comprising the flow guide 22. The radial flow guides 20 and central flow guides 22 continue in this alternating pattern through the working chamber 18. Each central flow guide 22 is separated from a downstream radial flow guide 20 by a spacer ring 34. The spacer ring 34 is either detachable or permanently fixed to a flow guide 20, 22 or housing 12, depending on the number of flow guides 20, 22 and the engineering design solutions.

A hollow cylinder 36 is disposed and tightly fitted in the central opening 32 of the central flow guide 22. The hollow cylinder 36 is fitted tightly against an inner peak surface 38 on the upstream radial flow guide 20 and is provided with side wall openings 40 (FIG. 2). The side wall openings 40 can be positioned at any location on the side wall of the hollow cylinder 36. The hollow cylinder 36 can have a circular, elliptical or polygonal cross-section. In the above-described configuration, the hollow cylinder 36 is mounted between two adjacent flow guides 20, 22 as depicted in FIG. 1.

The side wall openings 40 can be identical or have different shapes, as described below, and can be arranged in rows, columns, triangles, circles, squares, stars, crosses and/or other patterns. The axes of the side wall openings 40 can be aligned parallel to the radius of the cylinder 36 or be canted relative the central axis 26 of the cylinder 36 or the flow direction. For example, the side wall openings 40 may be canted clockwise or counterclockwise relative to the central axis 26 to produce corresponding clockwise or counterclockwise vortex jet streams within the hollow cylinder 36. The canted angle(s) can be the same for all side wall openings 40 or different for each side wall opening 40 and/or the group of side wall openings 40. The directions of flow jets resulting from some side wall openings 40 in a particular hollow cylinder 36 can be identical or opposite when compared to the directions of the flow jets coming off other side wall openings 40 on the same hollow cylinder 36. The inlets and outlets of side wall openings 40 can be round, square, rectangular, oval, star-like, slotted and/or virtually any other shape. The channels 42 of side wall openings 40 can be shaped as cylinders, cones, pyramids, Venturi tubes, an S-shape and/or have contraction(s) and/or expansion(s).

Since the cylinder 36 also functions as a spacer, spacer 34 is only required downstream of central flow guides 22 and not radial flow guides 20. Co-axial disc 44 is disposed in central opening 32 and abuts against hollow cylinder 36. The co-axial disc 44 is provided with channel(s) 46. The channels 46 of the disc 44 can be of the same or different shapes and/or sizes and can be arranged in groups. The openings of the channels 46 may be circular, oval, triangular, square, rectangular, slotted, trapezoidal, hexagonal, cross-shaped, diamond-shaped, heart-shaped, dumbbell-shaped, star-shaped, freeform-shaped, or any other known shape such as cloud, heart, leaf, etc. The cross-sections of the channels 46 and their openings can be shaped as a circle, star, square, rectangle or triangle or have a different shape. The channels 46 can cross within the body of the disc 44. Alternatively, the extended central axes of these channels 46 can cross outside the body of the disc 44. The superficial openings of the channels 46 can be spread evenly over the surfaces of the disc 44 or arranged in patterns. Hollow cylinder 36 and disc 44 are attached to each other and flow guides 20, 22, respectively, by means of threaded joints, tight fitting, gluing, magnetic force, stud(s) or other known methods.

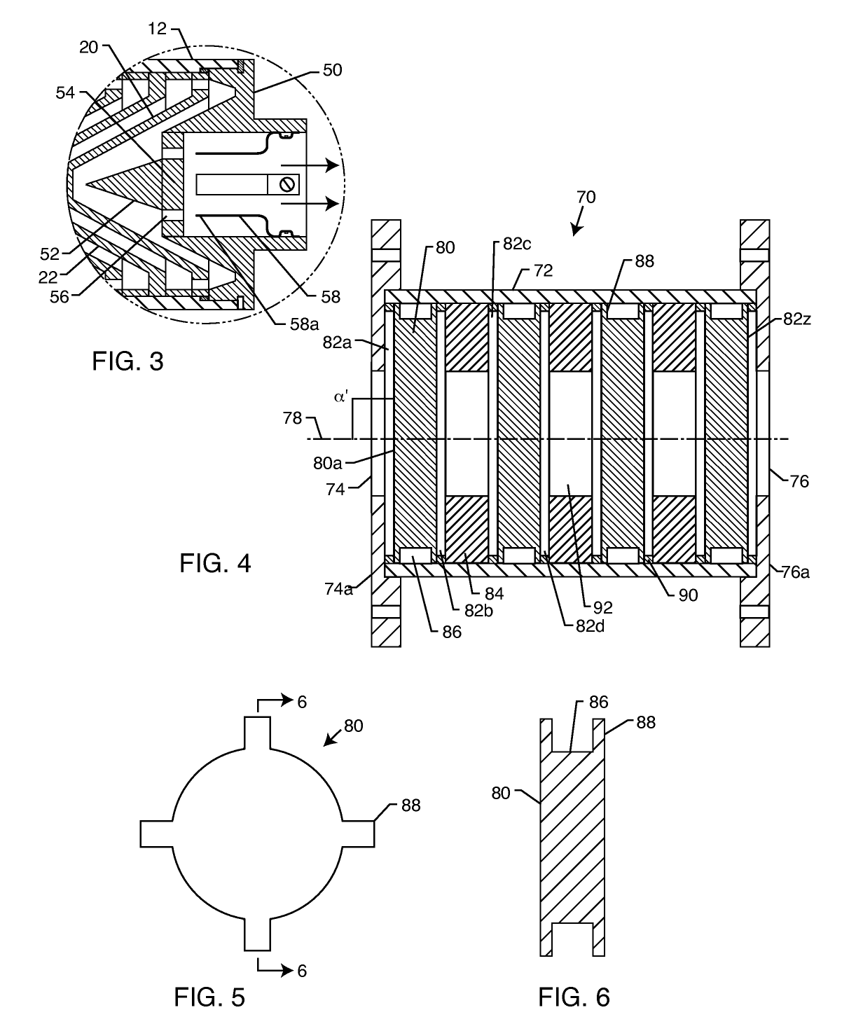

After the alternating series of flow guides 20, 22 and associated elements is a diffuser 48 disposed in end cap 50 that includes outlet pipe 16. The diffuser 48 is preferably conical in shape and may be configured in varied cross-sectional shapes, such as circular, elliptical or polygonal as the housing 12 or the flow guides 20, 22. As shown in FIG. 3, in an alternate embodiment, the diffuser 48 can house a baffle body 52 shaped as, for example, a pyramid, cone, semi-sphere, cube or differently shaped body. With this baffle body 52, the end cap 50 preferably includes end disc 54 provided with channels 56. The baffle body 52 is mounted on end disc 54 and is shaped as described. The channels 56 are disposed on the end disc 54 such that their openings are proximate to the edge of the baffle body 52. Strips 58 for generating acoustic vibrations are attached to the inner surface of outlet pipe 16. Such strips 58 may be attached by screws or by other known means. Strips 58 may be made from metal, plastic or other materials and have a profiled surface. The free end 58a of strip 58 is preferably sharp and positioned adjacent channels 56. Therefore, the number of strips 58 is equal to or less than the number of channels 56 in end disc 54.

The device 10 may be fully or partially made from materials having a high thermal conductivity. This high thermal conductivity will augment the effectiveness of the heat exchange properties described elsewhere herein. The device 10 may also be fully or partially fabricated from antibacterial, germicidal, antifungal and/or antiseptic materials. These materials preferably comprise copper, brass, copper alloys, zinc, nickel, silver and/or composite materials, including metal particles, nanomaterials and nanoparticles.

The device 10 works as follows: fluid is fed into inlet pipe 14 by an upstream discharge pump, a downstream sucking pump or a similar mechanism. The fluid then moves through expanding ring channel 60, which is formed radially around the surface of the first upstream radial flow guide 20. From the inlet pipe 14, the fluid flow first encounters the peak of the first upstream radial flow guide 20. From this point, the fluid flow moves along the tapered conical surface 28 which, with the inner wall of the housing 12, defines the first expanding ring channel 60a. As the fluid flow moves through this first expanding ring channel 60a, the fluid flow approaches the beaded flange 24 and radial openings 30 therein. When the fluid enters the radial openings 30 the formation of vortices and cavitation bubbles may occur. Depending on fluidic flow properties, the bubbles may implode in downstream chamber 62 resulting in the formation of numerous minute nuclei, i.e., submicron bubbles.

The fluid enriched with these submicron bubbles moves through the first tapering ring channel 60b, defined by the interior tapered conical surface 28a of the first upstream radial flow guide 20 and the exterior tapered conical surface 28 of the adjacent downstream central flow guide 22, and toward the first hollow cylinder 36. The pressure of the fluid gradually decreases while it travels through this tapering ring channel 60b because of the decreasing cross-sectional area. As a result of this pressure decrease, the minute nuclei give a rise to plentiful cavitation bubbles. The bubbles expand enhancing the downstream cavitation field intensity. The fluid then enters hollow cylinder 36 through side wall openings 40 and channels 42, collide with fluid from other side wall openings 40 inside the hollow cylinder 36 and forms a single vortex flow that flows through channels 46 in the co-axial disc 44. Flowing through channels 46 significantly intensifies bubble formation and growth.

The fluid then travels through a second expanding ring channel 60c similar to the first expanding ring channel 60a. As the bubbles move along the channel 60c, the hydrostatic pressure increases until a point is reached where the pressure on the outside of the bubble is greater than the pressure on the inside. The cavitation bubbles pulsate and implode releasing energy and heating the fluid. This intensifies processing and allows carrying out target reactions. The flow then enters a second tapered ring channel 60d similar to the first tapered ring channel 60b. This process repeats according to the number of flow guides 20, 22 in the working chamber 18.

Interlacing flow guides 20, 22 allows prompt heat transfer from ring channels 60 featuring gradually increasing and decreasing cross-sectional area and fluidic pressure in alternating channels. When the cavitation bubbles implode, heat is transferred to adjacent ring channels 60. The flow moves through the alternating ring channels 60, i.e., from the radial openings to the apex gradually accelerating and from the apex to the radial openings gradually decelerating. In the former, the fluid becoming enriched with cavitation bubbles and, in the latter, the cavitation bubbles imploding resulting in localized pressure and temperature increases. This particular feature makes the present device unique and especially suitable for the treatment of thermo-sensitive and flammable fluids of a high value.

The heat transfer between neighboring ring channels 60 with changing cross-sectional areas is determined by the thermal conductivity and surface area of the flow guides 20, 22, the flow velocity and other fluid parameters and conditions. The transferred heat enhances the efficiency of cavitation-assisted treatment by lowering the cavitation threshold in bordering zones. It should be emphasized that the heat exchange between the high-pressure and low-pressure chambers allows for the advanced control of cavitation making the present device 10 especially suitable for processing thermal sensitive biological fluids and pharmaceuticals, preheating of viscous liquids such as crude oil, diesel and vegetable oils, treating flammable organic solvents, etc. The important advantage of the device's distinct chamber-in-chamber design is the apparatus' reduced length, which is approximately equal to one-half that of traditional flow-through cavitation devices.

After passing through the upstream elements of the device 10, the flow passes around baffle body 52 in end cap 50, where it enters channels 56 of disc 54. The fluid then reaches sharpened strips 58 forming oscillating vortices. Cavitation inception is likely to occur on the vibrating strip 58, provided sufficient amplitude and acceleration is generated. With vortex pulsation frequency reaching intrinsic frequencies of the strips 58, resonance is established and the pulsation amplitude escalates. There is a further drop in pressure due to shock and turbulence. The vibration of strips 58 generates acoustic oscillations and vortices in the flow. The outcome of all these pressure drops is the creation of low-pressure regions in the proximity to the vibrating strips, which promote the formation of cavitation bubbles that implode in outlet pipe 16.

In order to create the conditions that are most suitable for nucleation, formation, growth, pulsation, rupture and the collapse of cavitation bubbles, the present device comprises a stack of the conical low-pressure chambers 60b, 60d, etc., interlaced with the conical high-pressure chambers 60a, 60c, etc. The first preferred embodiment of the device 10 provides at least one cavitation zone, preferably more than one. The exact location and the number of cavitation zones depends on the device's design and the fluidic flow properties. The number of sets comprised of one radial flow guide 20, one central flow guide 22, one hollow cylinder 36 and one co-axial disc 44 in the device 10 depicted in FIG. 1 is at least one. This design allows adding any number of such sets to create additional cavitation zones. One of the numerous advantages of the preferred embodiment is its versatility in respect to fluid feeding. The device 10 can be used in reverse mode by feeding fluid in outlet pipe 16, assuming the flow moves directionally from right to left.

The second preferred embodiment of the device 70 is shown in FIGS. 4-6 can also be made of STELLITE® alloy, steel, stainless steel, aluminum, copper, brass, silver, zinc, nickel, PTFE, FEP or other fluoropolymers, Plexiglas, PEEK, PBAT, PETG, PVC, polycarbonates, acrylic materials, polycrystalline diamond or other finished or unfinished material(s). The device 70 comprises a housing 72, an inlet pipe 74 and an outlet pipe 76 for connecting in-line with an industrial pipeline (not shown). This embodiment of the device 70 is characterized by a 90° exterior right angle α′ between a central axis 78 and a facing surface 80a of radial flow guide 80.

The flange 74a of inlet pipe 74 and the first downstream radial flow guide 80 are separated by circular channel 82a. Assuming fluidic flow from left to right, the flow moves radially from the central axis 78 to the side wall of the housing 72 in this circular channel 82a. Radial flow guide 80 and a downstream bushing or central flow guide 84 are separated by circular channel 82b wherein flow moves from the side wall of the housing 72 to the central axis 78. A spacer ring 90, which comprises an annular ring the size of the diameter of the housing 72 having a large central opening, is disposed between each radial flow guide 80 and central flow guide 84 pair. A spacer ring 90 is also disposed between the flange 74a of the inlet 84 and the first guide 80, as well as the flange 76a of the outlet 76 and the last guide 80.

Each radial flow guide 80 is provided with radial openings 86 and radial wings 88 for aligning the guide 80 within housing 70. Alternatively, radial flow guides 80 can be provided with slotted openings that can be arranged in patterns. The angles between the faces of guides 80, 84 and the central axis 78 are all right angles. The diameter of the channels 82 is equal to the diameter of the central opening of spacer ring 90. The width of the channels 82 is equal to the width of spacer ring 90. The bushing or central flow guide 84 has a central opening 92 shaped as a circle, oval, triangle, square, rectangle, trapezoid, diamond, heart, hexagon, multi-pointed star, cross, dumbbell, slot, leaf, cloud or any other free form shape. One of the numerous advantages of the device 70 of the second preferred embodiment is its versatility in respect to the direction of flow. Since the device comprises identical sets of flow pressure-affecting elements it can be used in reverse mode by feeding fluid in outlet pipe 76, assuming the flow moves from right to left.

The cavitation mixing device 70 manufactured in accordance with the second preferred embodiment functions as follows: fluid fed in inlet pipe 74 with an upstream discharge pump and/or downstream suction pump moves through first narrow circular channel 82a forming cavitation bubbles. The fluid then flows through radial openings 86 made in guide 80 which results in a decrease of the rate of fluidic flow and the implosion of numerous cavitation bubbles. The flow enriched with tiny gas nuclei enters downstream channel 82b. The tiny bubbles readily grow and pulsate while flowing through the channel 82b. The formed bubbles implode in opening 92a releasing a significant amount of energy and enriching the flow with nuclei. After passing sequentially through a plurality of alternating upstream elements of the device 70, the flow exits the device 70 through outlet pipe 76 that can be connected to a sucking pump, if needed.

The last circular channel 82z can house a baffle body such as a pyramid, cone, semi-spherical body, cube or a body of different shape as in the alternate embodiment depicted in FIG. 3. The outlet pipe 76 of the second preferred embodiment can be configured as depicted in FIG. 3 to accommodate this structure. When configured in this alternate embodiment, the outlet pipe 16 is replaced by a structure similar to end cap 50 that includes an outlet pipe 16. The diffuser 48 of the end cap 50 can house a baffle body 52 as described. An end disc 54 provided with channels 56 is disposed immediately downstream of the baffle body 52 such that the channels 56 are proximate to the edge of the baffle body 52. This alternate construction of the outlet pipe 76 may or may not include the vibrating strips 58 as described above.

The exact location and the number of cavitation zones provided by the second preferred embodiment may vary depending on the fluidic flow properties and device's design, for example the cross-sectional area of circular channels 82, radial openings 86, and central openings 92. Guides 80, 84 of the apparatus transfer heat from hot zones to cooler regions.

The devices 10, 70 are used for carrying into effect the present invention. Fluids can be treated continuously or periodically by passing them through the multi-stage chamber-in-chamber device 10, 70 comprised of the bubble generating zones, as well as the higher-pressure chambers meant for their implosion. The device 10, 70 can be placed anywhere around a manufacturing, processing or production site. The placement of one device 10, 70 can be combined with the placement of one or more other devices.

The bubbles' implosion results in the release of a significant amount of energy that drives reactions and processes and heats the fluid. The size of the bubbles depends on the properties of the fluid, the design of the cavitation device, the pump pressure and other fluid conditions. In practice, the pump pressure is gradually increased until a cavitation field of proper intensity is established. In addition to determining the size, concentration and composition of the bubbles, and, as a consequence, the amount of released energy, the inlet pressure governs the outcome of triggered reactions.

The preferred embodiments of the present invention optimize the cavitation to afford uniform cavitation of fluids and hence, alteration thereof, by applying the most suitable pump pressure. The cavitation employed in accordance with the preferred embodiments of the present invention is achieved with a pump pressure selected from the range of approximately 25-5,000 psi to afford the highest efficiency of the treatment. However, as one familiar in the art can imagine, different media require different energies obtained through cavitation in order for their alteration to occur. Therefore, this range is in no way intended to limit use of the present invention.

It becomes an equipment cost decision which device 10, 70 to employ, since a number of approaches are technically feasible, whether for large scale upgrading or the treatment of small batches. One approach for ensuring the best conditions is to create uniform cavitation throughout the fluid flow to avoid wasting energy. Additional lines and skid systems can be added to scale up the production capacity. These systems can be easily mounted and transported, making them suitable for both production and transportation.

The beneficial effects gained through the present invention cannot be achieved with a rotor-stator cavitation or sonic-/ultrasonic-induced cavitation because the conditions created by using the inventive apparatus 10, 70 cannot be duplicated by other means. For example, cavitation bubbles form a barrier to transmission and attenuate sonic waves due to scattering and diversion, limiting the effectiveness of sonic-/ultrasonic-induced cavitation. Furthermore, ultrasonic radiation modifies liquid at specific locations, depending on the frequency, interference patterns and the source's power. The present invention overcomes these limitations, changing the composition of fluid in a uniform adjustable manner by supplying enough energy to drive target reactions and processes. Therefore, the inventive device 10, 70 provides a superior means of upgrading fluids and producing unrivalled emulsions and dispersions.

The present invention uses the energy released as a result of the cavitation bubbles' implosion to alter fluids. Hydrodynamic cavitation is the formation of vapor-filled cavities in the fluid flow followed by the collapse of the bubbles in a high-pressure zone. In practice, the process is carried out as follows: the fluid is fed in the device's inlet passage. In the localized zone the flow accelerates causing its static pressure to drop resulting in the formation of bubbles composed of the vapors of compounds that vaporize under the specific conditions. When the bubbles move to the zone wherein the flow pressure increases, the bubbles collapse, exposing the vapors found within to high pressure and temperature, shearing forces, shock waves and/or electromagnetic radiation. Each bubble represents an independent miniature reactor, in which chemical and physical alterations take place. The resulting pressures and temperatures are significantly higher than those in many industrial processes. The further transformation of fluid results from the reactions and processes occurring in the adjacent layers of vapor/liquid.

The preferred embodiments of the present invention apply optimized levels of both pressure and temperature via the controlled flow-through cavitation and heat transfer from high-temperature zones to cooler regions. The process is independent of external conditions and provides a means for changing the chemical composition, physical properties and/or other characteristics of fluidic mixtures uniformly throughout the flow. In addition, important economic benefits are experienced through implementing the present invention. The optimized usage of a flow-through cavitation device serves to lower equipment, handling and energy costs, as it improves efficiency and productivity of the treatment.

### EXAMPLES

Intense localized heat released because of micro jet formation and compression of cavitation bubbles followed by the implosion of the bubbles, excite molecules existing in the vapor phase and the adjacent layers of surrounding fluid transiently enriched with the high-boiling ingredient(s), thereby driving target reactions and processes.

### Example 1

Since emulsion stability is affected by mixing time and intensity, cavitation devices can be compared by determining the stability of water/oil emulsions prepared with these systems, measuring the fading of dyes due to the cavitation-induced formation of peroxide in aqueous solutions or carrying out iodide oxidation in the accordance with the Weissler reaction (Chen and Tao, 2005; Morison and Hutchinson, 2009; Wang et al, 2009).

The stability of prepared emulsions was characterized with a coefficient kₜ, value for which was calculated by using the following expression: kₜ=Vₒ/V, where Vₒ is the volume of oil separated from the emulsion at time t and V is the total volume. Emulsions were prepared with a cavitation device 70 similar to that shown in FIG. 4 wherein the number of radial plates 80, was 6, the number of central flow plates 84 was 6 and the width of the spacer rings 90 was 0.9 mm. First, vegetable oil was added to an equal amount of water followed by mechanical agitation at 20° C. for 10 min. Second, the mixture was fed in the inventive device 70 at a pump pressure of 235 psi and a rate of 26 gallons per minute and subjected to either 2 or 20 passes through the device 70. Then 100 ml of the prepared emulsion was transferred to a transparent measuring cylinder. The value of coefficient kₜ was determined at different times (Table 1). The obtained data confirm that water/oil emulsions prepared with no surfactants by using the present device are more stable than those prepared by mechanical agitation.

TABLE 1

| | t | | | | | | |
|---|---|---|---|---|---|---|---|
| | 0.5 min | 30 min | 1 h | 2 h | 3 h | 4 h | 6 h |
| 2 Passes | 0.00 | 0.08 | 0.22 | 0.35 | 0.43 | 0.48 | 0.50 |
| kₜ, | | | | | | | |
| 20 Passes | 0.00 | 0.12 | 0.18 | 0.24 | 0.28 | 0.30 | 0.31 |
| kₜ, | | | | | | | |

### Example 2

Values for cavitation number, calculated with program ANSYS for the chamber-in-chamber cavitation device 10 (length 20 cm, diameter 15 cm, inlet pressure 690 psi) which is similar to the apparatus shown in FIG. 1, were 0.88 and 0.12 for the zones located downstream of the first and second openings 46, respectively, assuming flow moves from left to right.

### Example 3

Values for cavitation number, calculated with program ANSYS for the cavitation device 70 shown in FIG. 4 provided with 4 radial flow plates 80 and 3 central flow plates 84 at inlet pressure of 499 psi, were 0.95, 0.74, 0.59, 0.15 and 0.89, 0.66, 0.38, 0.08 in the first, second, third and forth radial openings 86 and first, second and third central openings 92, and outlet pipe 76, respectively, for each successive flow plate 80, 84, assuming flow moves from left to right.

Although the description above contains much specificity, this description should not be construed as limiting the scope of the invention, but as merely providing illustrations of some of the preferred embodiments of the present invention offering many potential uses for the products of the invention. The readers should comprehend that many other embodiments of the present invention are possible as understood by those skilled in this art. For example, there are many approaches to creating cavitation in fluids in addition to the ones described above. Accordingly, the scope of the present invention should be determined solely by the appended claims and their legal equivalents, rather than by the given examples.

Although several embodiments of the invention have been described in detail for purposes of illustration, various modifications of each may be made without departing from the spirit and scope of the invention. Accordingly, the invention is not to be limited, except as by the appended claims.

What is claimed is:

1. A compact, flow-through nanocavitation mixer apparatus with chamber-in-chamber design for advanced heat exchange, comprising:
an elongated housing having an inlet and an outlet, defining a working chamber between the inlet and the outlet, and having a central axis passing longitudinally through the center of the housing;
a first radial flow guide disposed concentrically in the working chamber about the central axis and proximate to the inlet, said first radial flow guide having a radial opening adjacent to an inner wall of the housing; and
a first central flow guide disposed concentrically in the working chamber about the central axis and proximate to the outlet, said first central flow guide having a central opening about the central axis.

2. The apparatus of claim 1, wherein the first radial flow guide and the first central flow guide are generally conical in shape and nested one within the other.

3. The apparatus of claim 2, wherein each of the first radial flow guide and the first central flow guide have exterior tapered conical surfaces configured such that an exterior angle α between the exterior tapered conical surface and the central axis is between zero degrees and one hundred eighty degrees.

4. The apparatus of claim 3, wherein the exterior angle α is preferably between one hundred fifteen degrees and one hundred fifty degrees.

5. The apparatus of claim 2, further comprising a hollow cylinder having a first end disposed in the central opening in a sealed manner and a second end abutting against the first radial flow guide in a sealed manner, the hollow cylinder having a plurality of side wall openings disposed around the axis of the hollow cylinder and passing through the side wall of the hollow cylinder.

6. The apparatus of claim 5, further comprising a coaxial disc disposed in the central opening in a sealed manner and abutting against the first end of the hollow cylinder, the coaxial disc having a channel passing therethrough.

7. The apparatus of claim 5, wherein the side wall openings are arranged in rows or columns around the hollow cylinder and are canted relative to the central axis, wherein each of the plurality of sidewall openings are canted at the same angle or at different angles.

8. The apparatus of claim 6, further comprising a plurality of channels passing through the coaxial disc, wherein said channels can cross within the coaxial disc or along extended axes of the channels outside the coaxial disc.

9. The apparatus of claim 2, further comprising a plurality of alternating radial and central flow guides, wherein a particular central flow guide is spaced from a preceding radial flow guide by a hollow cylinder affixed in the central opening and abutting against said preceding radial flow guide, and wherein a particular radial flow guide is spaced from a preceding central flow guide by a spacer ring abutting against both flow guides.

10. The apparatus of claim 1, further comprising a diffuser in the outlet, wherein the diffuser is configured as a cone with a gradually expanding cross-sectional area.

11. The apparatus of claim 10, wherein the diffuser is connected to a hollow cylinder, the hollow cylinder disposed in the central opening of the first central flow guide and in an abutting relationship to a second radial flow guide proximate to the outlet.

12. The apparatus of claim 1, further comprising an end cap in the outlet, said end cap having a generally elongated, cylindrical opening, an end disc disposed in the end cap and a baffle body mounted on the end disc oriented toward a second radial flow guide proximate to the outlet.

13. The apparatus of claim 12, further comprising outlet channels through the end disc, said outlet channels disposed around the perimeter of the baffle body.

14. The apparatus of claim 13, further comprising vibration strips mounted in the end cap such that a free end of each of the vibration strips is disposed adjacent to one of said outlet channels.

15. The apparatus of claim 1, wherein the first radial flow guide and the first central flow guide are generally planar in shape such that a right angle exists between a facing surface of the flow guides and the central axis.

16. The apparatus of claim 15, further comprising a second radial flow guide disposed proximate to the outlet, between the outlet and the first central flow guide.

17. The apparatus of claim 16, wherein said inlet comprises an inlet flange and said outlet comprises an outlet flange, further comprising a first spacer ring between the first radial flow guide and the inlet flange and a second spacer ring between the second radial flow guide and the outlet flange.

18. The apparatus of claim 15, further comprising a plurality of alternating radial and central flow guides, wherein a particular radial flow guide is spaced from an adjacent central flow guide or an inlet or outlet flange by a spacer ring abutting against both.

19. The apparatus of claim 1, wherein the first radial flow guide and the first central flow guide are made from materials selected from the group consisting of a STELLITE® alloy, steel, stainless steel, aluminum, copper, brass, silver, zinc, nickel, PTFE, FEP or other fluoropolymers, poly (methyl methacrylate), PEEK, PBAT, PETG, PVC, polycarbonates, acrylic materials, polycrystalline diamond and UV or visible light transparent material.

20. The apparatus of claim 19, wherein all parts of the compact, flow-through nano-cavitation mixer apparatus are made from materials selected from the group consisting of a STELLITE® alloy, steel, stainless steel, aluminum, copper, brass, silver, zinc, nickel, PTFE, FEP or other fluoropolymers, poly (methyl methacrylate), PEEK, PBAT, PETG, PVC, polycarbonates, acrylic materials, polycrystalline diamond and UV or visible light transparent material.
